(19) United States
(12) Patent Application Publication
(10) Pub. No.: US 2014/0222602 A1
(43) Pub. Date: Aug. 7, 2014

(54) INFORMATION PROCESSING APPARATUS AND METHOD FOR DETECTING STAIN ON IAMGE CAPTURING SURFACE THEREOF

(71) Applicant: TOSHIBA TEC KABUSHIKI KAISHA, Tokyo (JP)

(72) Inventor: Hidemi Mihara, Shizuoka-ken (JP)

(73) Assignee: TOSHIBA TEC KABUSHIKI KAISHA, Tokyo (JP)

(21) Appl. No.: 14/165,880

(22) Filed: Jan. 28, 2014

(30) Foreign Application Priority Data
Feb. 7, 2013 (JP) 2013-022530

(51) Int. Cl. G06Q 20/20; G06K 9/32; G06K 9/00

(52) U.S. Cl. CPC G06Q 20/209; G06Q 20/208; G06K 9/00523; G06K 9/3241
USPC 705/23

(57) ABSTRACT

An information processing apparatus comprises an image capturing module configured to capture image of a commodity, an extraction module configured to extract feature amount of the commodity from the image captured by the image capturing module, a calculation module configured to calculate a similarity degree by comparing feature amount of each standard commodity with the feature amount of the commodity extracted by the extraction module, a recognition module configured to recognize a standard commodity of which the similarity degree calculated by the calculation module is greater than a given value as a candidate of the commodity, a detection module configured to detect, from a plurality of captured images captured by the image capturing module, a static object existing in the captured image, and a notification module configured to notify the detection of a stain if the static object is continuously detected in the plurality of captured images by the detection module for a given time.

### CROSS-REFERENCE TO RELATED APPLICATION

This application is based upon and claims the benefit of priority from Japanese Patent Application No. 2013-022530, filed Feb. 7, 2013, the entire contents of which are incorporated herein by reference.

### FIELD

Embodiments described herein relate to an information processing apparatus and method for detecting a stain on the image capturing surface of the apparatus.

### BACKGROUND

Conventionally, a code reading apparatus is used in a store and the like to read a code symbol such as a barcode attached to a commodity with a scanner. In such a code reading apparatus, the reading operation is hindered if there is a stain on the reading surface of the scanner. Thus, a technology is proposed in which a message indicating that there is a stain within the scanning range is notified.

Further, recently, there exists an object recognition apparatus for recognizing (identifying) a category and the like of a commodity by extracting a feature amount of the commodity from image data obtained by photographing the commodity, and comparing the extracted feature amount with the pre-prepared feature amount for comparison. In the object recognition apparatus also, if there is a stain on the image capturing surface of the image capturing apparatus, the precision of the acquired feature amount decreases, which may lead to an incorrect recognition. Therefore, it is preferred that a massage indicating that there is a stain is notified even in the object recognition apparatus. However, the conventional technology mentioned above cannot be applied to the object recognition apparatus directly due to the difference in constitution and reading (photographing) target.

### BRIEF DESCRIPTION OF THE DRAWINGS

FIG. 1 is a perspective view illustrating an external constitution of a checkout system according to an embodiment;

FIG. 2 is a block diagram illustrating hardware arrangement of a POS terminal and a commodity reading apparatus shown in FIG. 1;

FIG. 3 is a diagram schematically illustrating one example of data configuration of a PLU file shown in FIG. 2;

FIG. 4 is a block diagram illustrating functional components of the POS terminal and the commodity reading apparatus shown in FIG. 1;

FIG. 5 is a diagram illustrating an example of a commodity candidate displayed on a display device of the commodity reading apparatus;

FIG. 6 is a diagram illustrating operations of a second detection section shown in FIG. 4;

FIG. 7 is a diagram illustrating operations of the second detection section shown in FIG. 4;

FIG. 8 is a diagram illustrating one example of a notification screen displayed by a notification section shown in FIG. 4;

FIG. 9 is a diagram illustrating an another example of a notification screen displayed by the notification section shown in FIG. 4;

FIG. 10 is a flowchart illustrating a procedure of a commodity recognition processing executed by a commodity reading apparatus;

FIG. 11 is a flowchart illustrating a procedure of a sales registration processing executed by a POS terminal;

FIG. 12 is a flowchart illustrating a procedure of a stain detection processing executed by a commodity reading apparatus;

FIG. 13 is a perspective view illustrating a constitution of a self-checkout POS according to an embodiment; and

FIG. 14 is a block diagram illustrating hardware arrangement of the self-checkout POS shown in FIG. 13.

### DETAILED DESCRIPTION

In accordance with one embodiment, an information processing apparatus comprises an image capturing module, an extraction module, a calculation module, a recognition module, a detection module, and a notification module. The image capturing module captures image of a commodity. The extraction module extracts feature amount of the commodity from the image captured by the image capturing module. The calculation module calculates a similarity degree by comparing feature amount of each standard commodity with the feature amount of the commodity extracted by the extraction module. The recognition module recognizes a standard commodity of which the similarity degree calculated by the calculation module is greater than a given value as a candidate of the commodity. The detection module detects, from a plurality of captured images captured by the image capturing module, a static object existing in the captured image. The notification module notifies the detection of a stain if the static object is continuously detected in the plurality of captured images by the detection module for a given time.

Hereinafter, taking a checkout system as an example, an information processing apparatus and program according to the present embodiment are described with reference to the accompanying drawings. A store system is a checkout system (POS system) comprising a POS terminal for registering and settling the commodities in one transaction. The present embodiment is an example of application to a checkout system introduced to a store such as a supermarket and the like.

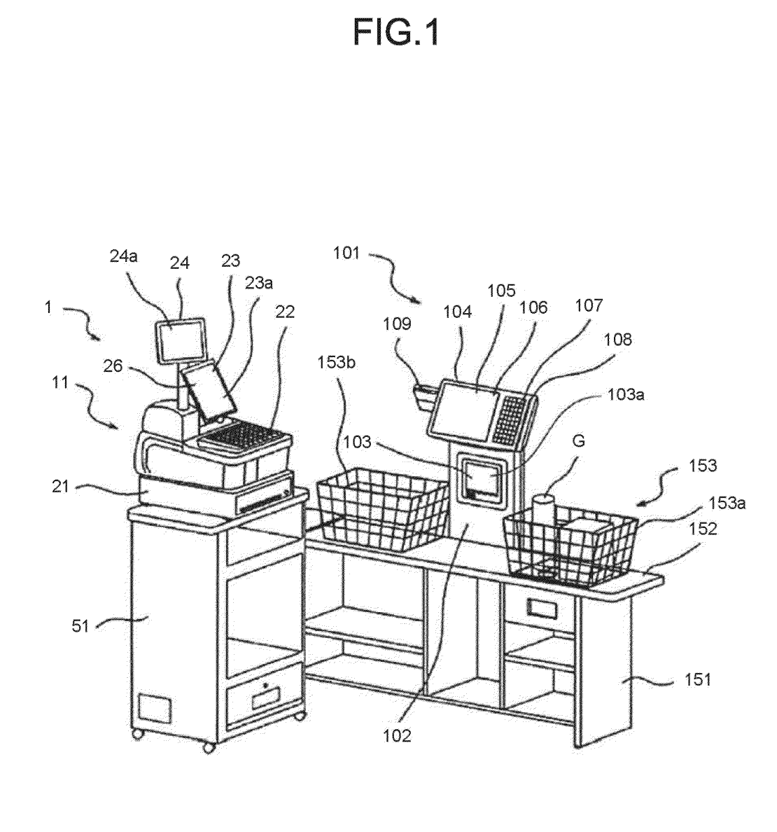

FIG. 1 is a perspective view illustrating an external constitution of a checkout system 1. As shown in FIG. 1, the checkout system 1 comprises a POS terminal 11 and a commodity reading apparatus 101 serving as an information processing apparatus.

The POS terminal 11 is placed on a drawer 21 on a checkout counter 51. The drawer 21 is opened or closed under the control of the POS terminal 11. A keyboard 22 is arranged on the upper surface of the POS terminal 11 for an operator (shop clerk) to operate the POS terminal 11. A display device 23 for displaying information to the operator is arranged at a position opposite to the operator with respect to the keyboard 22. The display device 23 displays information on a display screen 23a thereof. A touch panel 26 is laminated on the display screen 23a. A display for customer 24 is vertically arranged to be rotatable at a backside to the display device 23. The display for customer 24 displays information on a display screen 24a thereof.

The display for customer 24 shown in FIG. 1 is in a state in which the display screen 24a thereof faces the operator in FIG. 1, however, the display for customer 24 can be rotated such that the display screen 24a is directed to a customer.

A horizontally elongated counter table 151 is arranged to be in an L-shape with the checkout counter 51 on which the POS terminal 11 is placed. A commodity receiving surface 152 is formed on the counter table 151. Shopping basket 153 which receives a commodity G therein is placed on the commodity receiving surface 152. It can be considered to classify the shopping baskets 153 into a first shopping basket 153a held by a customer and a second shopping basket 153b placed facing the first shopping basket 153a across the commodity reading apparatus 101.

The commodity reading apparatus 101, which is connected with the POS terminal 11 to be capable of sending and receiving data, is arranged on the commodity receiving surface 152 of the counter table 151. The commodity reading apparatus 101 comprises a thin rectangular housing 102.

A reading window 103 is arranged at the front side of the housing 102. A protective glass 103a having a light permeability is firmly fitted into the reading window 103. A display and operation section 104 is installed on the upper portion of the housing 102. A display device 106 on the surface of which a touch panel 105 is laminated is arranged on the display and operation section 104. A keyboard 107 is arranged at the right side of the display device 106. A card reading slot 108 of a card reader (not shown) is arranged at the right side of the keyboard 107. A display for customer 109 is arranged at the left side of the display and operation section 104.

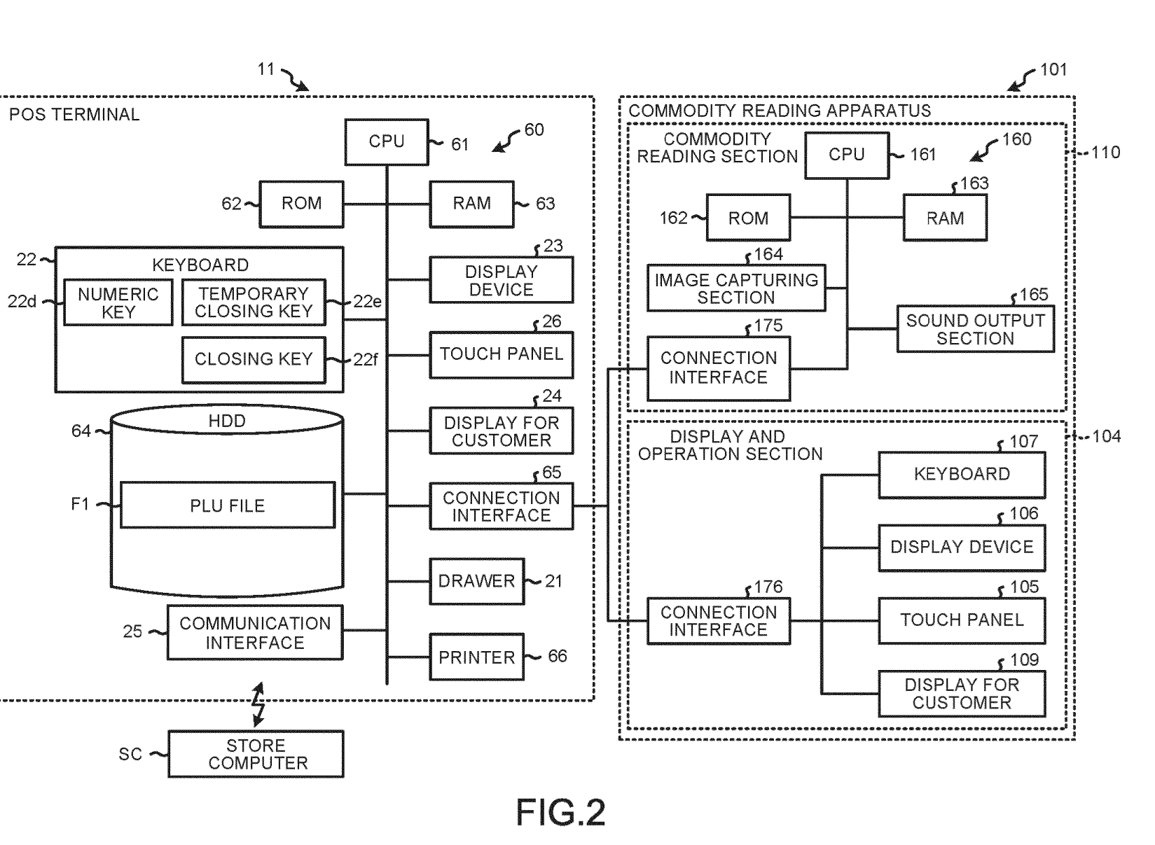

Commodities G purchased in one transaction are put in the first shopping basket 153a held by a customer. The commodities G in the first shopping basket 153a are moved one by one to the second shopping basket 153b by the operator who operates the commodity reading apparatus 101. During the movement, the commodity G is directed to the reading window 103 of the commodity reading apparatus 101. At this time, an image capturing section 164 (referring to FIG. 2) arranged in the reading window 103 captures images of the commodity G through the protective glass 103a.

FIG. 2 is a block diagram illustrating the hardware arrangement of the POS terminal 11 and the commodity reading apparatus 101.

The POS terminal 11 comprises a microcomputer 60 serving as an information processing section for executing information processing. The microcomputer 60 comprises a CPU (Central Processing Unit) 61 which executes various arithmetic processing and controls each section, a ROM (Read Only Memory) 62 and a RAM (Random Access Memory) 63. The ROM 62 stores programs executed by the CPU 61.

The drawer 21, the keyboard 22, the display device 23, the display for customer 24, a communication interface 25 and the touch panel 26 are all connected with the CPU 61 of the POS terminal 11 via various input/output circuits (not shown).

The keyboard 22 includes numeric keys 22d on which numeric characters such as ‘1’, ‘2’, ‘3’ . . . and operators such as multiplying operator ‘*’ are displayed, a temporary closing key 22e and a closing key 22f.

An HDD 64 stores various programs and files. When the POS terminal 11 is started, the programs stored in the HDD 64 are all or partially developed on the RAM 63 and executed by the CPU 61.

The HDD 64 stores data files such as a PLU file F1 and the like. The PLU file F1 is readable from the commodity reading apparatus 101 via a connection interface 65.

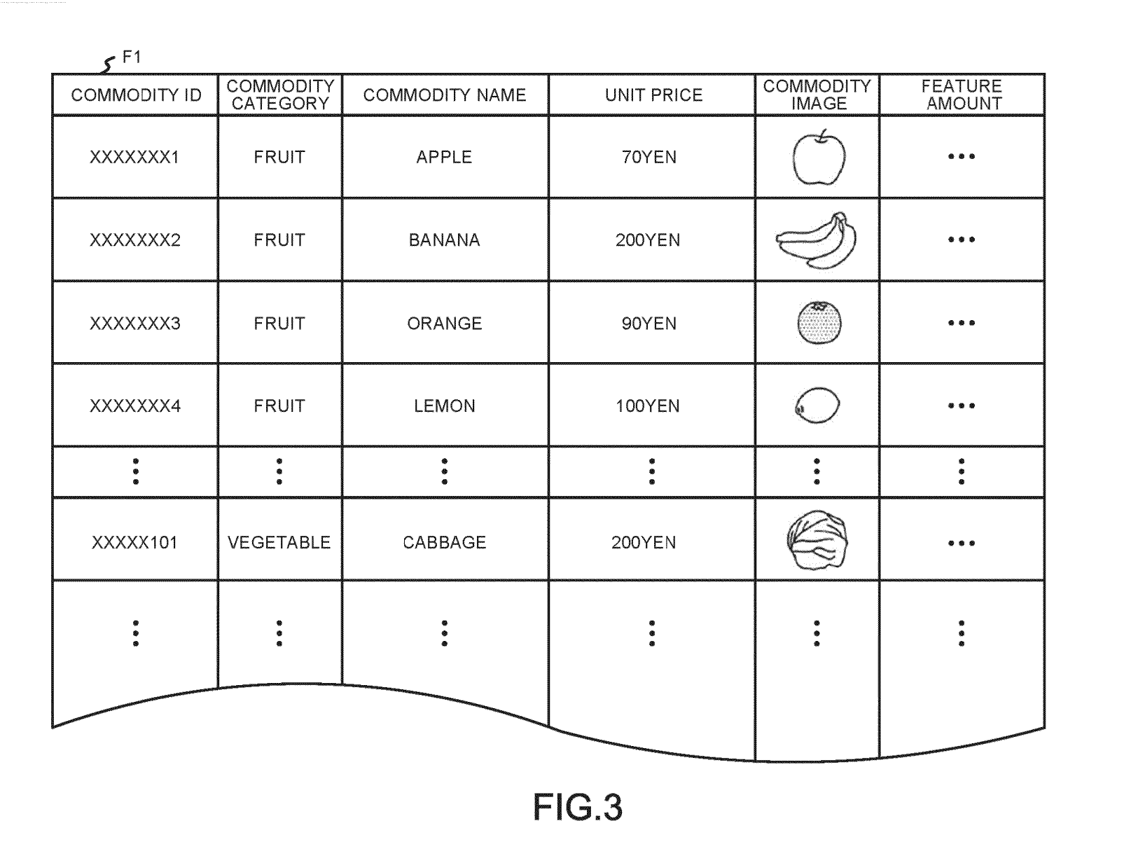

The PLU file F1 is a data file in which a commodity G sold in the store is associated with information relating to the sales registration of the commodity G. FIG. 3 is a diagram schematically illustrating an example of the data configuration of the PLU file F1. As shown in FIG. 3, a commodity ID uniquely assigned to each commodity G, information relating to a commodity such as a commodity category to which the commodity G belongs, a commodity name and a unit price, and a commodity image obtained by photographing the commodity G, for each commodity are registered in association with one another in the PLU file F1. Further, in the PLU file F1, feature amount of a commodity (feature amount data of a standard commodity) is also registered (stored) in association with each commodity G in advance.

The commodity image is obtained by photographing each standard commodity to be compared at the time of the similarity degree determination which will be described later. The commodity image is indicated as an image showing the commodity candidate at the time of indication of a commodity candidate described later. Further, the feature amount of a commodity G pre-extracted from the captured image (for example, a commodity image) of each commodity G is registered in association with corresponding commodity ID. Herein, the feature amount refers to the information representing the feature of the commodity G such as the hue, pattern, concave-convex state, shape and the like of the surface of a commodity G.

In the present embodiment, the feature amount of each commodity G is registered in the FLU file F1 in advance, however, it is not limited to this, and the feature amount may be extracted from each commodity image by a feature amount extraction section 1613 described later. Further, instead of a commodity image, an image for indication may also be registered. Hereinafter, each commodity registered in the PLU file F1 is referred to as a registration commodity.

Returning to FIG. 2, the communication interface 25 for executing data communication with the store computer SC is connected with the CPU 61 of the POS terminal 11 through the input/output circuit (not shown). The store computer SC is arranged at a backyard and the like in a store. The HDD (not shown) of the store computer SC stores the PLU file F1 sent to the POS terminal 11, a stock management file for managing the stock state of each registration commodity registered in the PLU file F1, and the like.

The connection interface 65 enables the data transmission/reception with the commodity reading apparatus 101. The commodity reading apparatus 101 is connected with the connection interface 65. A receipt printer 66 is provided in the POS terminal 11. The POS terminal 11 prints content of one transaction on a receipt with the receipt printer 66 under the control of the CPU 61.

The commodity reading apparatus 101 comprises a commodity reading section 110 and a display and operation section 104. The commodity reading section 110 comprises a microcomputer 160. The microcomputer 160 comprises a CPU 161, a ROM 162 and a RAM 163. The ROM 162 stores programs executed by the CPU 161.

An image capturing section 164, a sound output section 165 and a connection interface 175 are connected with the CPU 161 through various input/output circuits (not shown). The operations of the image capturing section 164, the sound output section 165 and the connection interface 175 are controlled by the CPU 161.

The image capturing section 164, which is a color CCD sensor or a color CMOS sensor, is an image capturing module for carrying out an image capturing through the reading window 103. For example, motion images are captured by the image capturing section 164 at 30 fps. The frame images (captured images) sequentially captured by the image capturing section 164 at a given frame rate are stored in the RAM 163. In addition, the background of the captured image is preferred to be substantially single color (for example, black) by adjusting the exposure of the image capturing section 164 and the backlight (not shown) and the like. Thereby, the commodity G held in front of the reading window 103 can be captured more clearly.

The sound output section 165 includes a sound circuit and a speaker and the like for issuing a preset alarm sound and the like. The sound output section 165 gives a notification through a sound such as an alarm sound under the control of the CPU 161.

The display and operation section 104 comprises the touch panel 105, the display device 106, the keyboard 107, the display for customer 109, and a connection interface 176. The connection interface 175 of the commodity reading section 110, which is connected with the connection interface 65 of the POS terminal 11, enables the data transmission/reception with the POS terminal 11. The connection interface 175 connects with the display and operation section 104 through the connection interface 176, and the CPU 161 carries out data transmission/reception between the commodity reading section 110 and the display and operation section 104 through the connection interface 175.

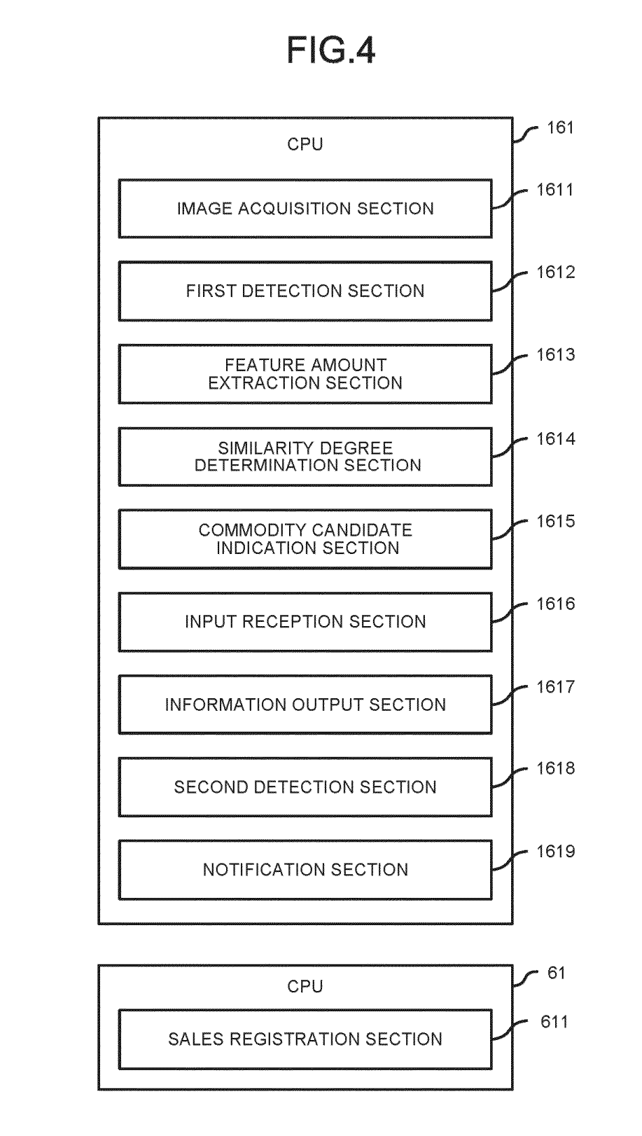

Next, the functional components of the CPU 161 and the CPU 61 realized by executing the programs by the CPU 161 and the CPU 61 are described below with reference to FIG. 4.

FIG. 4 is a block diagram illustrating the functional components of the POS terminal 11 and the commodity reading apparatus 101. As shown in FIG. 4, the CPU 161 of the commodity reading apparatus 101 executes programs sequentially to function as an image acquisition section 1611, a first detection section 1612, a feature amount extraction section 1613, a similarity degree determination section 1614, a commodity candidate indication section 1615, an input reception section 1616, an information output section 1617, a second detection section 1618 and a notification section 1619.

The image acquisition section 1611 outputs an ON-signal of image capturing to the image capturing section 164 to enable the image capturing section 164 to start an image capturing operation. The image acquisition section 1611 acquires the images, which are captured by the image capturing section 164 after the image capturing operation is started and stored in the RAM 163, in sequence. The image acquisition section 1611 acquires the captured images from the RAM 163 in the order of storing them to the RAM 163.

The first detection section 1612 detects the whole or part of the contour line of a commodity G contained in the captured image acquired by the image acquisition section 1611 using a known pattern matching technology. Next, by comparing the contour line extracted from the last time captured image (frame image) with the contour line extracted from the current captured image (next to the last time), a different part, that is, a reflection image area of a commodity G directed to the reading window 103 is detected.

As another method for detecting a commodity G, it is determined whether or not a flesh color area is detected from the captured image. If the flesh color area is detected, that is, the reflection image of the hand of a shop clerk is detected, the detection of the aforementioned contour line nearby the flesh color area is carried out to try to extract the contour line of the commodity G that is assumed to be held by the shop clerk. At this time, if a contour line representing the shape of a hand and the contour line of another object nearby the contour line of the hand are detected, the commodity G is detected from the contour line of the object.

The feature amount extraction section (extraction module) 1613 extracts the surface state (surface hue, pattern, concave-convex state, shape and the like) of the commodity G detected by the first detection section 1612 from the captured image acquired by the image acquisition section 1611 as a feature amount.

The similarity degree determination section (calculation module) 1614 compares the feature amount of each registration commodity registered in the PLU file F1 of the POS terminal 11 with the feature amount extracted by the feature amount extraction section 1613. Further, the similarity degree determination section 1614 specifies, from the PLU file F1, the registration commodity (commodity ID) of which the similarity degree representing how much similar the two feature amounts are according to the comparison result is greater than a given threshold value.

More specifically, the similarity degree determination section 1614 reads the feature amount of each registration commodity (commodity ID) from the PLU file F1 in sequence, and compares the feature amount of the commodity G contained in the captured image with each registration commodity to calculate the similarity degree there between. Then, the similarity degree determination section (recognition module) 1614 recognizes the registration commodity (commodity ID) the similarity degree of which is greater than the given threshold value as a candidate of the commodity G photographed by the image capturing section 164. Herein, the similarity degree may be a value (similarity degree), which is obtained by comparing the feature amount of the commodity G with the feature amount of each registration commodity in the PLU file F1, representing how much similar the two feature amounts are. The concept of the similarity degree is not limited to the example above. The similarity degree may be a value representing the degree of coincidence with the feature amount of each registration commodity registered in the PLU file F1, or a value representing the degree of correlation between the feature amount of the commodity G and the feature amount of each registration commodity registered in the PLU file F1.

The recognition of an object contained in an image as stated above is referred to as a general object recognition. As to the general object recognition, various recognition technologies are described in the following document.

Keiji Yanai “Present situation and future of generic object recognition”, Journal of Information Processing Society, Vol. 48, No. SIG16 [Search on Heisei 25 Jan. 24], Internet <URL: http://mm.cs.uec.ac.jp/IPSJ-TCVIM-Yanai.pdf>

In addition, the technology carrying out the general object recognition by performing an area-division on the image for each object is described in the following document.

Jamie Shotton etc, “Semantic Texton Forests for Image Categorization and Segmentation”, [Search on Heisei 25 Jan. 24], Internet <URL: http://citeseerx.ist.psu.edu/viewdoc/download?doi=10.1.1.145.3036&rep=rep1&type=pdf>

In addition, no limitation is given to the method for calculating the similarity degree. For example, the similarity degree can be calculated as an absolute evaluation or a relative evaluation. If the similarity degree is calculated as an absolute evaluation, the captured image of the commodity G and each of the registered commodities are compared one by one, and the similarity degree obtained from the comparison result can be adopted as it is. If the similarity degree is calculated as a relative evaluation, the similarity degree is obtained as long as the sum of the similarity degrees between the captured commodity G and each registration commodity becomes 1.0 (100%). On the other hand, if the registration commodity the similarity degree of which is above the given threshold value doesn't exist, the similarity degree determination section 1614 cooperates with the commodity candidate indication section 1615 to display, on the display device 106, a message informing that the commodity needs to be selected manually using a commodity list described later.

The commodity candidate indication section 1615 displays the information relating to the registration commodity recognized as a candidate by the similarity degree determination section 1614 on the display device 106 as a commodity candidate. More specifically, the commodity candidate indication section 1615 reads the record of the registration commodity recognized as a candidate from the PLU file F1 of the POS terminal 11, and displays it on the display device 106.

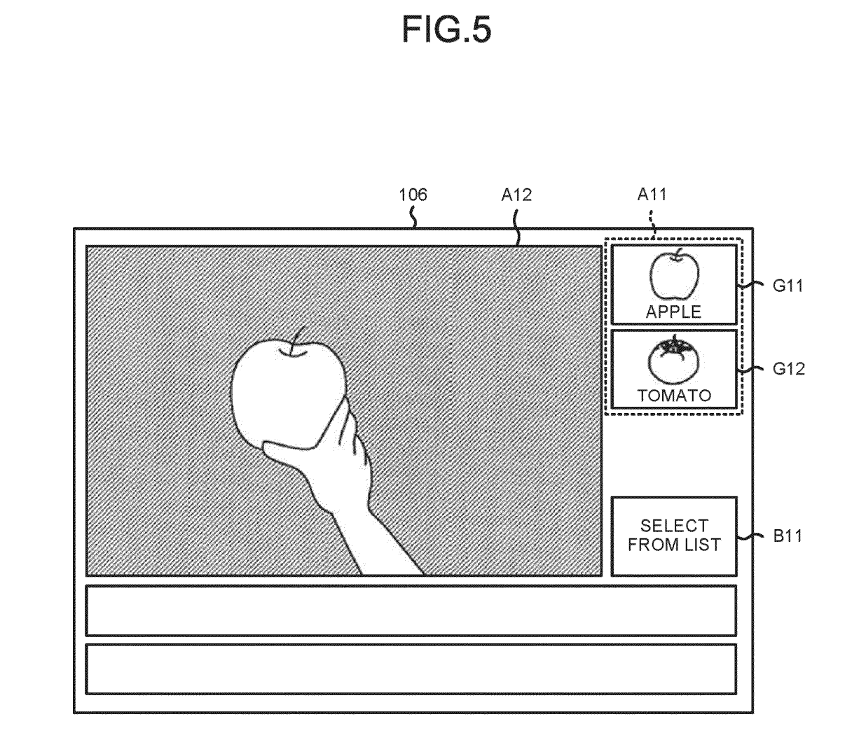

FIG. 5 is a diagram illustrating an example of display of the commodity candidate. As shown in FIG. 5, in the display screen of the display device 106, commodity images G11, G12 contained in the record of the commodity candidate are displayed together with corresponding commodity names in a commodity candidate indication area A11 in a descending order of similarity degree of the registration commodity. These commodity images G11, G12 are set to be selectable in response to a touch operation on the touch panel 105. Further, a selection button B11 for selecting a commodity from the commodity list is arranged below the commodity candidate indication area A11. The commodity selected from the commodity list is processed as a determined commodity described later. Further, an image captured by the image capturing section 164 is displayed in an area A12. In FIG. 5, it is shown as one example that two commodity candidates are indicated. However, the display method and the number of the commodity candidates indicated are not limited to this.

Returning to FIG. 4, the input reception section 1616 receives various input operations corresponding to the display of the display device 106 through the touch panel 105 or the keyboard 107. For example, the input reception section 1616 receives a selection operation of one commodity candidate from the commodity candidates displayed on the display device 106. The input reception section 1616 receives the selected commodity candidate as the commodity (determined commodity) corresponding to the commodity G photographed by the image capturing section 164. In a case that the first detection section 1612 has a capability of detecting a plurality of commodities G, the input reception section 1616 may receive selection operations of a plurality of commodity candidates from the commodity candidates.

The information output section 1617 outputs the information (for example, the commodity ID, the commodity name and the like) indicating the commodity determined in the aforementioned manner to the POS terminal 11 through the connection interface 175.

The information output section 1617 may also output the sales volume input separately through the touch panel 105 or the keyboard 107 to the POS terminal 11 together with the commodity ID and the like. As to the information output to the POS terminal 11 by the information output section 1617, the commodity ID read from the PLU file F1 by the information output section 1617 may be notified directly, or the commodity name, file name of the commodity image capable of specifying the commodity ID may be notified, or the storage location of the commodity ID (storage address in the PLU file F1) may also be notified.

The second detection section (detection module) 1618 detects the stain on the protective glass 103a from the image captured by the image capturing section 164. More specifically, the second detection section 1618 detects a static part (hereinafter referred to as a static object) from a plurality of captured images which are continuous in a time basis.

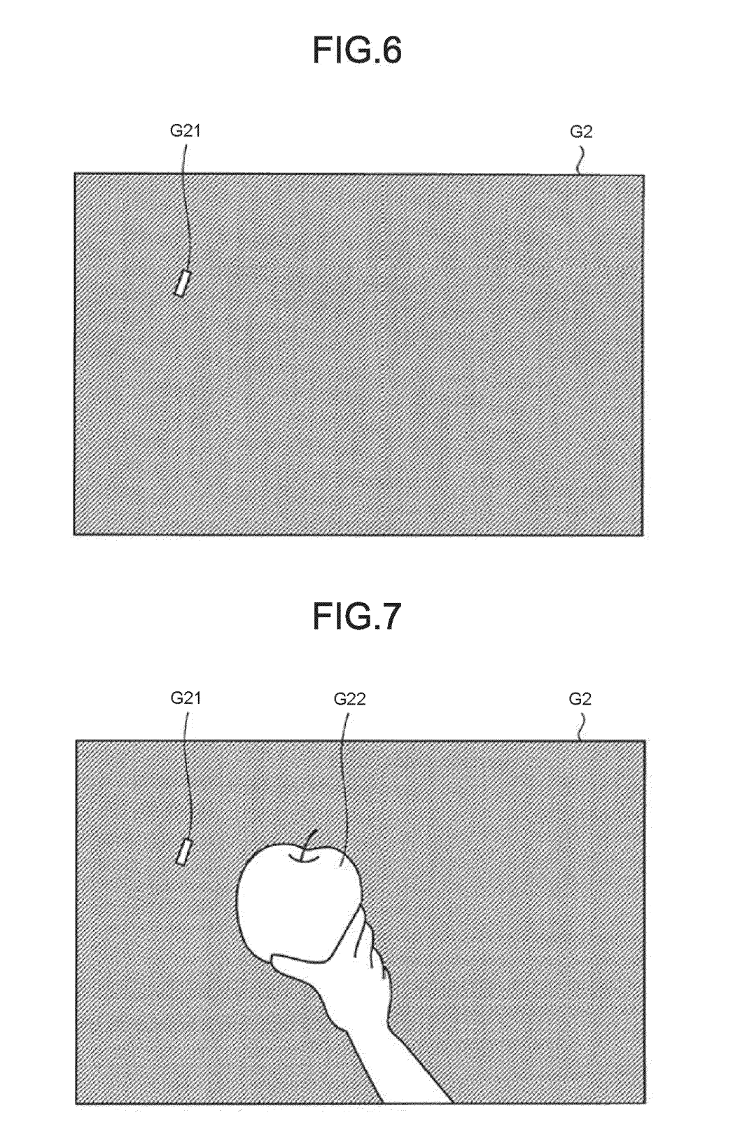

FIG. 6 and FIG. 7 are diagrams illustrating the operations of the second detection section 1618, in which an example of a captured image G2 acquired by the image acquisition section 1611 is exemplified. As shown in FIG. 6, if there is a stain on the protective glass 103a, an image G21 showing the stain is contained in the image G2 captured by the image capturing section 164. In FIG. 6, a state in which no commodity G is held in front of the reading window 103 is illustrated.

In the state shown in FIG. 6, if a commodity G is held in front of the reading window 103, an object image G22 of the commodity G is contained in the image G2 captured by the image capturing section 164, as shown in FIG. 7. At this time, since the location of the stain on the protective glass 103a is not changed, the image G21 exists at the same location as that in FIG. 6.

In the second detection section 1618, as shown in FIG. 6 and FIG. 7, the motion vector of each part (pixel) in the captured image G2 can be detected by comparing the captured images G2 acquired by the image acquisition section 1611 in sequence. Then the second detection section 1618 detects, from the plurality of captured images, the pixel group (image G21) of which the motion vector is almost zero, that is, the pixel group (image G21) located at the same position and having the same shape, as a static object.

Returning to FIG. 4, if the second detection section 1618 continuously detects the static object for a given time, the notification section (notification module) 1619 determines that the static object is the stain on the protective glass 103a. Then, the notification section 1619 notifies the shop clerk that a stain is detected through the display device 106 or the sound output section 165. In the present embodiment, “stain” includes dirt, a fingerprint and a flaw or a scrape as well on the protective glass 103a.

The given time used for the determination of stain is preferred to be longer (for example, 10 minutes and the like) than that needed for the recognition by the similarity degree determination section 1614. Or, it may be a continuous time, or an accumulated value of discrete time. For example, the static object is detected for a first time period at the first image capturing operation of the image capturing section 164, and then the image capturing operation is stopped. Then, the static object is further detected for a second time period at the next image capturing operation. In this case, it can be determined that the stain is detected if the total time period of the first time period and the second time period is greater than the given time.

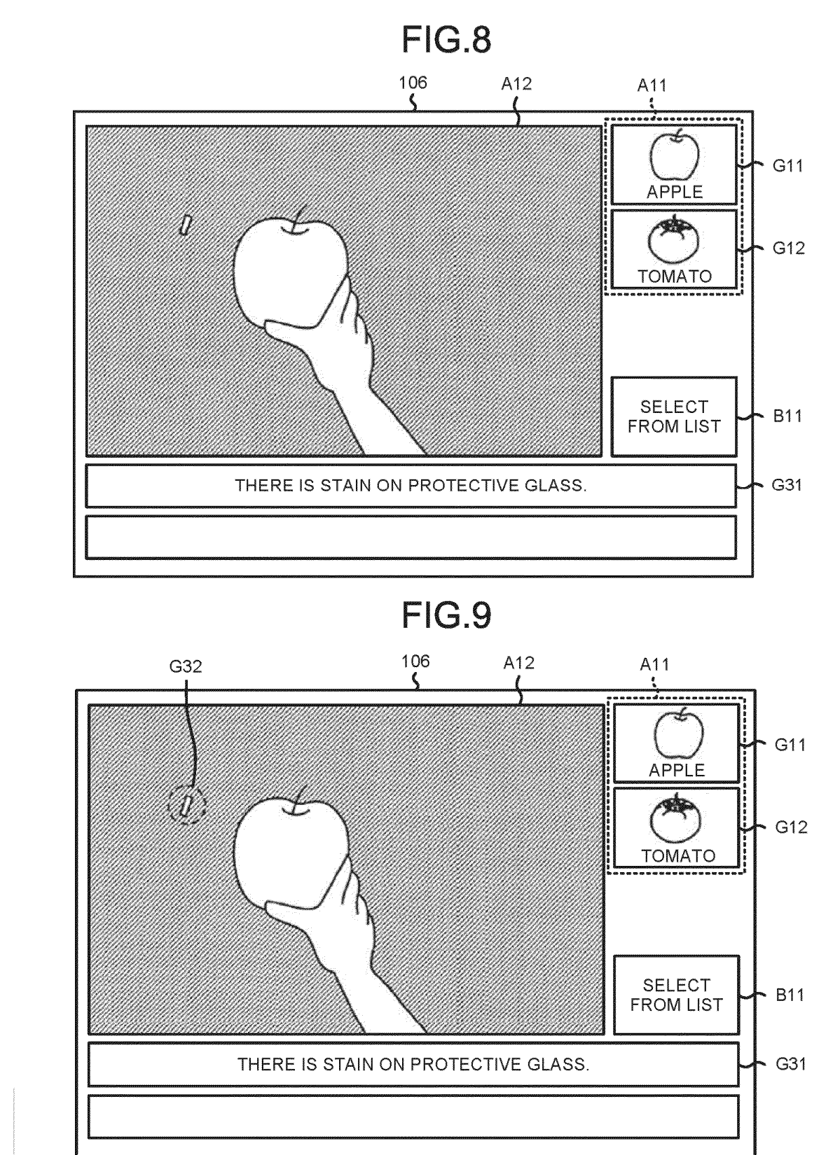

FIG. 8 is a diagram illustrating an example of a notification screen displayed by the notification section 1619. In FIG. 8, a message notifying the detection of the stain is displayed as a notification image G31 on the screen shown in FIG. 5. The display position of the notification image G31 and the content of the message are not limited to the example shown in FIG. 8.

Further, since the position of the stain (static object) in the captured image can be specified according to the detection result of the second detection section 1618, the position of the stain may be notified. Specifically, the position of the stain is specified as position of a pixel within the pixels constituting the captured image. Therefore, the position of the stain can be notified by indicating the position of the pixel.

FIG. 9 is a diagram illustrating another example of the notification screen. In FIG. 9, in the screen shown in FIG. 5, the notification image G31 is displayed as well as a marker image G32 at the position of the stain in the captured image. Notifying the position of the stain makes it easy for the shop clerk to grasp the position of the stain, which can make it more convenient to remove the stain.

Incidentally, the position of the stain shown in the captured image is reverse to the actual position seen from the shop clerk in a left and right direction (horizontal direction) because the image capturing direction of the image capturing section 164 is reverse to the eyes direction of the shop clerk when he or she looks at the reading window 103. Thus, a captured image that is processed in a mirror image inversion in the left and right direction is displayed in the area A12, and the position of the stain in the captured image may be notified with the marker image G32. The method for notifying the position of the stain is not limited to the marker image G32, and a message indicating the position of the stain may also be displayed or notified through a sound, for example, a message of “there is a stain at the upper right part on the protective glass 103al ” and the like.

If a stain sticks to the protective glass 103a, there may be a possibility that the precision of the feature amount extracted by the feature amount extraction section 1613 is low, which may lead to an incorrect recognition. Thus, the recognition operation of the commodity G may be inhibited during a period in which the notification section 1619 notifies the detection of a stain. Specifically, the recognition operation of the commodity G is controlled by restraining the function of feature amount extraction section 1613 during a period in which the notification section 1619 notifies the detection of a stain.

Further, as another example, the notification section 1619 compares the reflection image area of the commodity G in the captured image detected by the first detection section 1612 with the position of the stain in the captured image to determine the inclusion-relation thereof. Then, if the notification section 1619 determines that the position of the stain is included in the reflection image area of the commodity G, the function of the feature amount extraction section 1613 is restrained to control the recognition operation of the commodity G.

Thereby, since the recognition operation of the commodity G can be controlled during the period in which a stain sticks to the protective glass 103a, the incorrect recognition due to the stain can be prevented.

Returning to FIG. 4, the CPU 61 of the POS terminal 11 has a function as a sales registration section 611 by executing programs. The sales registration section 611 carries out a sales registration of a commodity based on the commodity ID and the sales volume output from the information output section 1617 of the commodity reading apparatus 101. Specifically, the sales registration section 611 carries out, with reference to the PLU file F1, a sales registration by recording the notified commodity ID and the commodity category, commodity name and unit price specified with the commodity ID in a sales master file together with the sales volume.

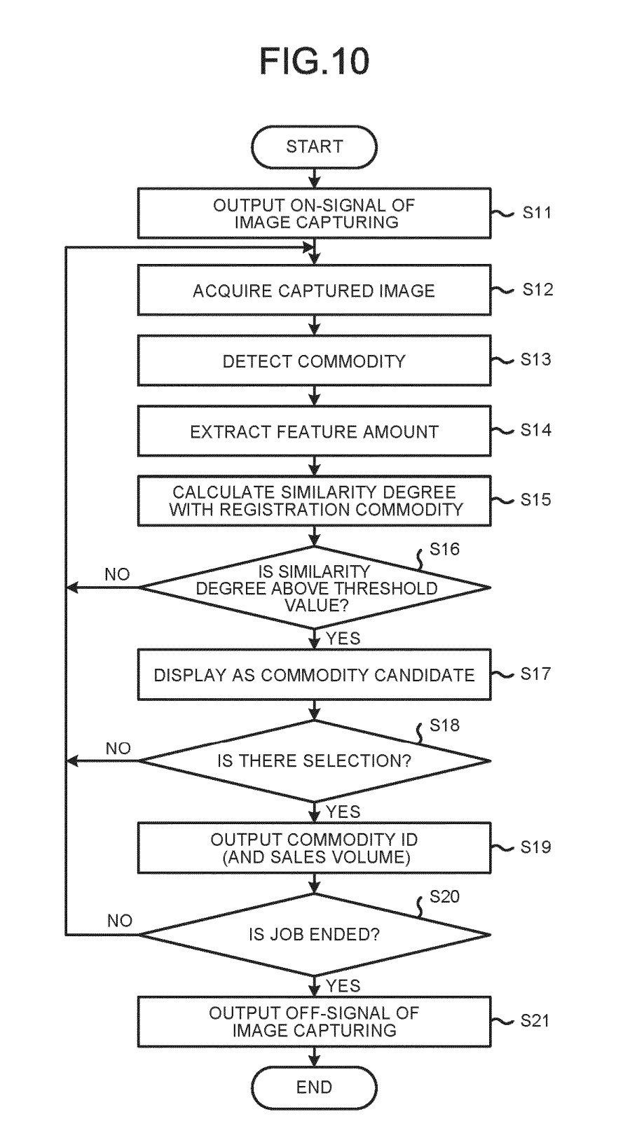

Hereinafter, the operations of the checkout system 1 are described. First, the operations relating to the recognition of the commodity G carried out by the commodity reading apparatus 101 are described. FIG. 10 is a flowchart illustrating the procedure of the commodity recognition processing executed by the commodity reading apparatus 101.

As shown in FIG. 10, when the processing is started in response to a start of the commodity registration by the POS terminal 11, the image acquisition section 1611 outputs an ON-signal of image capturing to the image capturing section 164 to enable the image capturing section 164 to start an image capturing operation (ACT S11).

The image acquisition section 1611 acquires a frame image (captured image) that the image capturing section 164 captures and stores in the RAM 163 (ACT S12). Next, the first detection section 1612 detects the whole or part of the commodity G from the captured image acquired in ACT S12 (ACT S13). The feature amount extraction section 1613 extracts the feature amount of the commodity G detected in ACT S13 from the captured image acquired in ACT S12 (ACT S14).

Next, the similarity degree determination section 1614 compares the feature amount extracted in ACT S14 with the feature amount of each registration commodity in the PLU file F1 to calculate similarity degrees respectively (ACT S15). Then, the similarity degree determination section 1614 determines whether or not there exists a registration commodity of which the similarity degree with the feature amount extracted in ACT S14 is greater than the threshold value (ACT S16) in the registration commodities the similarity degrees of which are calculated in ACT S15.

In ACT S16, if it is determined that there is a registration commodity of which the similarity degree is greater than the threshold value (YES in ACT S16), the feature amount extraction section 1613 recognizes the registration commodity as a candidate of the commodity G captured by the image capturing section 164, and thus ACT S17 is taken. If it is determined that there is no registration commodity of which the similarity degree is greater than the threshold value (NO in ACT S16), ACT S12 is taken.

Then, the commodity candidate indication section 1615 reads the record of the registration commodity recognized as a candidate in ACT S16 from the PLU file F1 of the POS terminal 11, and displays it on the display device 106 as a commodity candidate (ACT S17).

Next, the input reception section 1616 determines whether or not the selection of the commodity candidate is received through the touch panel 105 or the keyboard 107 (ACT S18). If the selection operation is received (YES in ACT S18), the input reception section 1616 receives the selected commodity candidate as the determined commodity corresponding to the commodity G photographed by the image capturing section 164, and then ACT S19 is taken. On the other hand, if no selection is received (NO in ACT S18), ACT S12 is taken.

Then, the information output section 1617 outputs the information such as the commodity ID representing the selected determined commodity to the POS terminal 11 through the connection interface 175 (ACT S19), and then ACT S20 is taken.

In a case in which the sales volume is input separately through the touch panel 105 or the keyboard 107, the sales volume is also output to the POS terminal 11 together with the information representing the determined commodity in ACT S19. If the sales volume is not input, the sales volume “1” may also be output as a default value.

In ACT S20, the CPU 161 determines whether or not the job is ended based on an end notification of the commodity registration from the POS terminal 11 (ACT S20). Herein, if the job is continued (NO in ACT S20), the CPU 161 returns to the processing in ACT S12 to continue the processing. If the job is ended (YES in ACT S20), the image acquisition section 1611 ends the image capturing of the image capturing section 164 by outputting an OFF-signal of image capturing to the image capturing section 164 (ACT S21), then the processing is ended.

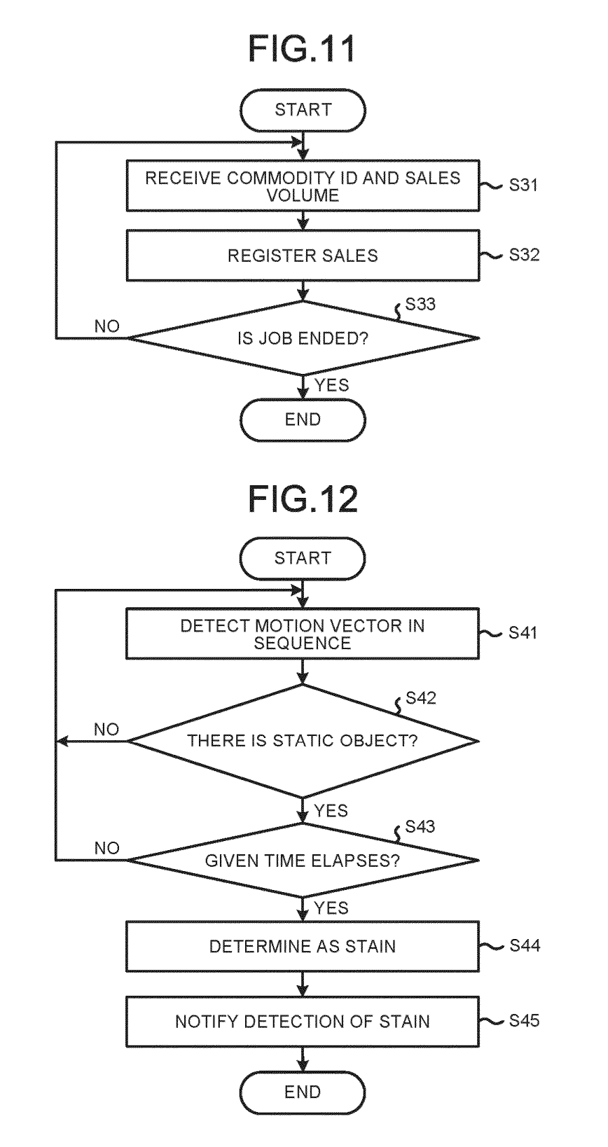

Next, the processing operations of the POS terminal 11 are described. FIG. 11 is a flowchart illustrating the procedure of the sales registration processing executed by the POS terminal 11.

First, when the processing is started in response to a start of the commodity registration according to an operation instruction through the keyboard 22, the CPU 61 receives the commodity ID and the sales volume of the determined commodity output by the commodity reading apparatus 101 in ACT S19 of FIG. 10 (ACT S31). Then, the sales registration section 611 reads the commodity category, the unit price and the like from the PLU file F1 based on the commodity ID and the sales volume received in ACT S31 and registers the sales of the commodity G read by the commodity reading apparatus 101 in the sales master file (ACT S32).

Then, the CPU 61 determines whether or not the job is ended based on an ending of the sales registration according to the operation instruction through the keyboard 22 (ACT S33). If the job is continued (NO in ACT S33), the CPU 61 returns to ACT S31 to continue the processing. If the job is ended (YES in ACT S33), the CPU 61 ends the processing.

Next, the operations relating to the stain detection executed by the commodity reading apparatus 101 are described. FIG. 12 is a flowchart illustrating the procedure of the stain detection processing executed by the commodity reading apparatus 101.

First, the second detection section 1618 compares the captured images acquired by the image acquisition section 1611 in sequence to detect the motion vector of each part in the captured image in sequence (ACT S41). Next, the second detection section 1618 determines whether or not there is a static object with the same shape at the same position in the captured images based on the motion vector of each part detected in ACT S41 (ACT S42). If there is no static object (NO in ACT S42), the processing in ACT S42 is executed, repeatedly.

On the other hand, in ACT S42, if a static object is detected (YES in ACT S42), the notification section 1619 determines whether or not the static object is continuously detected during the given time (ACT S43). If the static object is not continuously detected for the given time due to vanishing or moving the static object (NO in ACT S43), ACT S42 is taken.

In ACT S43, if the static object is continuously detected during the given time (YES in ACT S43), the notification section 1619 determines that the static object is a stain on the protective glass 103a (ACT S44). Then, the notification section 1619 notifies that a stain is detected through the display device 106 or the sound output section 165 (ACT S45), and then the present processing is ended.

As stated above, according to the present embodiment, in the commodity reading apparatus 101 carrying out recognition of a commodity G, a stain on the protective glass 103a serving as the image capturing surface of the image capturing section 164 is detected, and the message indicating that (detection of stain) is notified. Thereby, a shop clerk is urged to remove the stain, which conduces to make a better image capturing environment.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, in the embodiment stated above, the POS terminal 11 is arranged to include the PLU file F1, however, it is not limited to this, and all or part of the PLU file F1 may be included in the commodity reading apparatus 101.

Further, it is arranged in the embodiment stated above that the recognition of the commodity candidate is carried out in the commodity reading apparatus 101, however, all or part of the functional sections of the commodity reading apparatus 101 may be separated from the POS terminal 11.

For example, the POS terminal 11 may comprise the feature amount extraction section 1613 and the similarity degree determination section 1614, while the commodity reading apparatus 101 may comprise the image acquisition section 1611, the first detection section 1612, the commodity candidate indication section 1615, the input reception section 1616 and the information output section 1617. In this case, the commodity reading apparatus 101 transmits the captured image, which is acquired by the image acquisition section 1611 and from which the commodity is detected by the first detection section 1612, to the POS terminal 11. Further, the commodity reading apparatus 101 receives the result of the commodity (registration commodity) recognized by the POS terminal 11, and indicates the received result as a commodity candidate through the commodity candidate indication section 1615. Further, in a case in which the POS terminal 11 comprises all the functional sections of the commodity reading apparatus 101, the commodity reading apparatus 101 functions as an image capturing apparatus, and the POS terminal 11 carries out the display and selection of a commodity candidate based on the captured image sent from the commodity reading apparatus 101.

According to the embodiment stated above, the commodity reading apparatus 101 comprises the second detection section 1618 and the notification section 1619, however, it may be arranged that the POS terminal 11 comprises the two sections. In this case, the POS terminal 11 takes the captured images acquired by the image acquisition section 1611 in sequence, and carries out the operation of the detection and notification of the stain through the functions of the second detection section 1618 and the notification section 1619.

Further, in the embodiment stated above, a stain on the protective glass 103a is set to be the detection target, however, it is not limited to this, and a stain on the optical system (for example, lens and the like) of the image capturing section 164 may also be detected in the same manner.

Further, in the embodiment stated above, an example is exemplified where a stationary type scanner apparatus (commodity reading apparatus 101) is used, however, it is not limited to this, and any handy type scanner apparatus connected with the POS terminal 11 may be employed.

Further, according to the embodiment stated above, in a checkout system 1 consisting of the POS terminal 11 and the commodity reading apparatus 101, the present invention is applied to the commodity reading apparatus 101, however, it is not limited to this, and it may also be applied to an apparatus comprising all the functions of the POS terminal 11 and the commodity reading apparatus 101, or a checkout system constituted by, for example, connecting the commodity reading apparatus 101 and the POS terminal 11 shown in FIG. 1 in a wired or wireless manner. As an apparatus comprising all the functions of the POS terminal 11 and the commodity reading apparatus 101, a self-checkout apparatus (hereinafter referred to as a self POS in short) arranged and used in a store such as a supermarket and the like is listed.

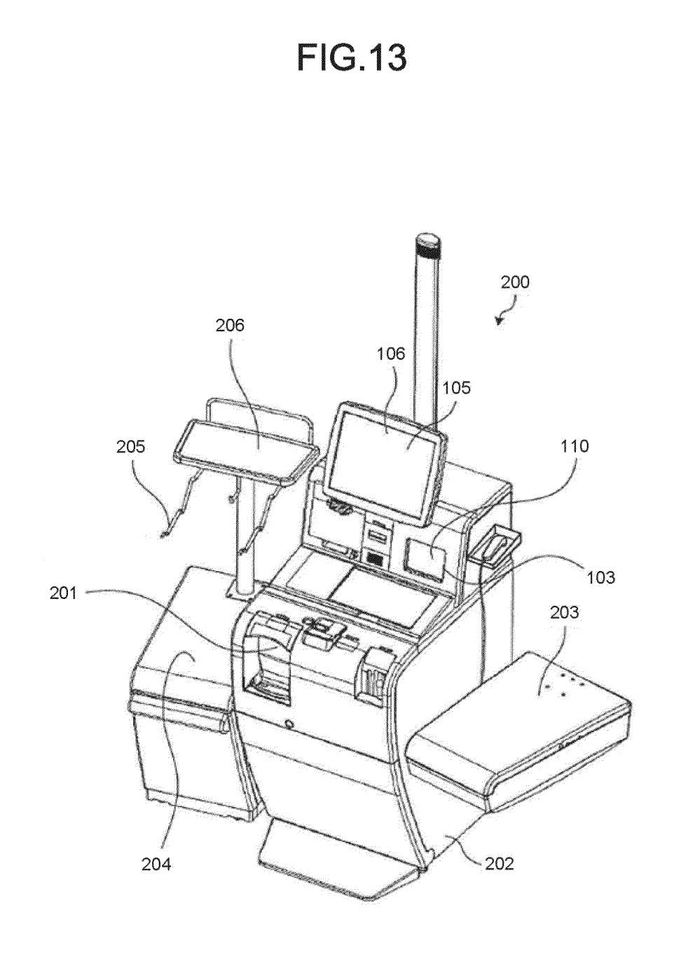

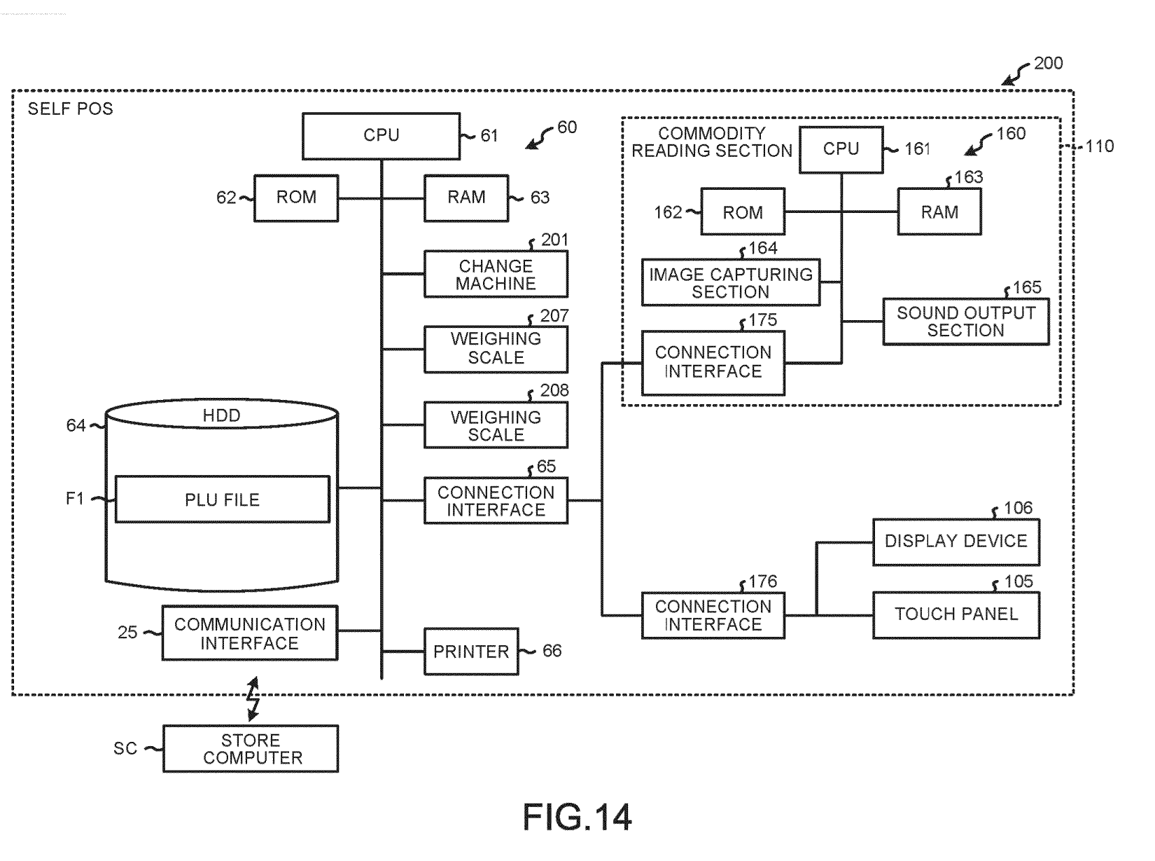

Herein, FIG. 13 is a perspective view illustrating the external constitution of the self POS 200, and FIG. 14 is a block diagram illustrating the hardware arrangement of the self POS 200. Hereinafter, the same numerals are applied to the components similar to that in FIG. 1 and FIG. 2, and the detailed descriptions thereof are not repeated.

As shown in FIG. 13 and FIG. 14, a main body 202 of the self POS 200 comprises a display device 106 having a touch panel 105 on the surface thereof and a commodity reading section 110 which reads a commodity image to recognize (detect) the category of a commodity.

The display device 106 may be, for example, a liquid crystal display. The display device 106 displays a guidance screen for providing customers a guidance for the operation of the self POS 200, various input screens, a registration screen for displaying the commodity information read by the commodity reading section 110 and a settlement screen, on which a total amount, a deposit amount and a change amount are displayed and through which a payment method can be selected.

The commodity reading section 110 reads a commodity image through the image capturing section 164 when the customer puts the code symbol attached to a commodity in front of the reading window 103 of the commodity reading section 110.

Further, a commodity placing table 203 for placing the unsettled commodity in a shopping basket is arranged at the right side of the main body 202, and, at the left side of the main body 202, a commodity placing table 204 for placing the settled commodity, a bag hook 205 for hooking a bag for placing the settled commodities therein and a temporary placing table 206 for placing the settled commodities temporarily before the settled commodities are put into a bag are arranged. The commodity placing tables 203 and 204 are provided with weighing scales 207 and 208 respectively, and are therefore capable of confirming whether or not the weight of commodities is the same before and after a settlement.

Further, a change machine 201 for inputting bill for settlement and outputting bill as change is arranged in the main body 202 of the self POS 200.

In the case in which the present invention is applied to the self POS 200 having such constitutions as described above, the self POS 200 functions as an information processing apparatus. Further, a single apparatus comprising the functions of the POS terminal 11 and the commodity reading apparatus 101 is not limited to the self POS having the above-constitutions and it may be an apparatus without having weighing scales 207 and 208.

Further, in the embodiment above, the programs executed by each apparatus are pre-incorporated in the storage medium (ROM or storage section) of each apparatus, however, the present invention is not limited to this, the programs may be recorded in a computer-readable recording medium such as CD-ROM, flexible disk (FD), CD-R, DVD (Digital Versatile Disk) in the form of installable or executable file. Further, the storage medium, which is not limited to a medium independent from a computer or an incorporated system, further includes a storage medium for storing or temporarily storing the downloaded program transferred via an LAN or the Internet.

In addition, the programs executed by each apparatus described in the embodiments above may be stored in a computer connected with a network such as the Internet to be provided through a network download or provided or distributed via a network such as the Internet.

Alternatively, the programs mentioned in the embodiments above may be incorporated in a portable information terminal such as a mobile phone having a communication function, a smart phone, a PDA (Personal Digital Assistant) and the like to realize the functions of the programs.

What is claimed is:

1. An information processing apparatus, comprising:
an image capturing module configured to capture image of a commodity;
an extraction module configured to extract feature amount of the commodity from the image captured by the image capturing module;
a calculation module configured to calculate a similarity degree by comparing feature amount of each standard commodity with the feature amount of the commodity extracted by the extraction module;
a recognition module configured to recognize a standard commodity of which the similarity degree calculated by the calculation module is greater than a given value as a candidate of the commodity;
a detection module configured to detect, from a plurality of captured images captured by the image capturing module, a static object existing in the captured image; and
a notification module configured to notify the detection of a stain if the static object is continuously detected in the plurality of captured images by the detection module for a given time.

2. The information processing apparatus according to claim 1, wherein the notification module carries out the notification through a display section or a sound output section.

3. The information processing apparatus according to claim 2, wherein the notification module notifies the position of the static object detected by the detection module using the captured image displayed on the display section.

4. The information processing apparatus according to claim 1, wherein the extraction of the feature amount carried out by the extraction module is restrained while the notification module notifies the detection of the stain.

5. The information processing apparatus according to claim 4, wherein the extraction of the feature amount carried out by the extraction module is restrained if the notification module notifies that the position of the static object detected by the detection module is included in an reflection image area of the commodity in the captured image.

6. A method, including:
capturing image of a commodity;
extracting feature amount of the commodity from the captured image;
calculating a similarity degree by comparing feature amount of each standard commodity with the feature amount of the extracted commodity;
recognizing a standard commodity of which the calculated similarity degree is greater than a given value as a candidate of the commodity;
detecting, from a plurality of captured images acquired, a static object existing in the captured image; and
notifying the detection of a stain if the static object is continuously detected in the plurality of captured images for a given time.
